(19) United States
(12) Patent Application Publication
(10) Pub. No.: US 2025/0310277 A1
(43) Pub. Date: Oct. 2, 2025

(54) PACKET PROCESSING METHOD AND APPARATUS APPLIED TO DPU, COMPUTER DEVICE AND STORAGE MEDIUM

(71) Applicant: Beijing Volcano Engine Technology Co., Ltd., Haidian District (CN)

(72) Inventors: Shoujing Bo, Beijing (CN); Yaobao Wang, Beijing (CN); Jian Wang, Beijing (CN)

(21) Appl. No.: 19/093,749

(22) Filed: Mar. 28, 2025

(30) Foreign Application Priority Data
Mar. 29, 2024 (CN) 202410382544.2

(51) Int. Cl. H04L 49/90; H04L 45/00

(52) U.S. Cl. CPC H04L 49/9026; H04L 45/38

(57) ABSTRACT

The present disclosure relates to the field of cloud computing technology, and discloses a packet processing method and apparatus applied to a DPU, a computer device, and a storage medium. The packet processing method includes: storing a received network packet in a buffer unit, where the network packet includes a first packet and a second packet, and a packet processing speed of the second transmission path is higher than a packet processing speed of the first transmission path; monitoring a buffer watermark of a packet buffer space of the buffer unit, where the buffer watermark is used to indicate a usage degree of the packet buffer space; and in response to the buffer watermark being greater than a preset threshold, sending the first packet in the buffer unit to the first transmission path.

### CROSS-REFERENCE TO RELATED APPLICATION

This application claims priority to Chinese Application No. 202410382544.2 filed on Mar. 29, 2024, the disclosure of which is incorporated herein by reference in its entirety.

### FIELD

The present disclosure relates to the field of cloud computing technology, and specifically, to a packet processing method and apparatus applied to a data processing unit, DPU, a computer device, and a storage medium.

### BACKGROUND

A cloud network can be used to implement abstraction of underlying physical network devices in a data center, so that network resources can be partitioned, integrated, or managed at a software layer. Therefore, the cloud network plays a very important role in the development of cloud computing.

### SUMMARY

In view of this, the present disclosure provides a packet processing method and apparatus applied to a data processing unit, DPU, a computer device, and a storage medium.

According to a first aspect, the present disclosure provides a packet processing method applied to a data processing unit, DPU. The method includes:

storing a received network packet in a buffer unit, where the network packet includes a first packet and a second packet, the first packet is used to be processed in a first transmission path, the second packet is used to be processed in a second transmission path, and a packet processing speed of the second transmission path is higher than a packet processing speed of the first transmission path;

monitoring a buffer watermark of a packet buffer space of the buffer unit, where the buffer watermark is used to indicate a usage degree of the packet buffer space; and

if the buffer watermark is greater than a preset threshold, sending the first packet in the buffer unit to the first transmission path.

According to a second aspect, the present disclosure provides a packet processing apparatus applied to a data processing unit, DPU. The apparatus includes:

a storing module, configured to store a received network packet in a buffer unit, where the network packet includes a first packet and a second packet, the first packet is used to be processed in a first transmission path, the second packet is used to be processed in a second transmission path, and a packet processing speed of the second transmission path is higher than a packet processing speed of the first transmission path;

a monitoring module, configured to monitor a buffer watermark of a packet buffer space of the buffer unit, where the buffer watermark is used to indicate a usage degree of the packet buffer space; and

a packet discarding module, configured to send the first packet in the buffer unit to the first transmission path according to the buffer watermark being greater than a preset threshold.

According to a third aspect, the present disclosure provides a computer device. The computer device includes a memory and a processor. The memory and the processor communicate with each other. The memory has a computer instruction stored therein. The processor executes the computer instruction, to perform the packet processing method according to the first aspect or any corresponding implementation of the first aspect.

According to a fourth aspect, the present disclosure provides a computer-readable storage medium. The computer-readable storage medium has a computer instruction stored thereon. The computer instruction is used to cause a computer to perform the packet processing method according to the first aspect or any corresponding implementation of the first aspect.

### BRIEF DESCRIPTION OF THE DRAWINGS

In order to more clearly describe the technical solutions in the specific implementations of the present disclosure or in the prior art, the following briefly introduces the drawings that need to be used in the description of the specific implementations or the prior art. Apparently, the drawings in the following description show some implementations of the present disclosure, and persons of ordinary skill in the art may still derive other drawings from these drawings without creative efforts.

FIG. 1 is a schematic flowchart of a packet processing method applied to a DPU according to an embodiment of the present disclosure.

FIG. 2 is a schematic flowchart of another packet processing method applied to a DPU according to an embodiment of the present disclosure.

FIG. 3 is a schematic flowchart of another packet processing method applied to a DPU according to an embodiment of the present disclosure.

FIG. 4 is a schematic diagram of a working principle of sending, by a network card device, a packet to a host device according to an embodiment of the present disclosure.

FIG. 5 is a schematic diagram of another working principle of sending, by a network card device, a packet to a host device according to an embodiment of the present disclosure.

FIG. 6 is a schematic flowchart of another packet processing method applied to a DPU according to an embodiment of the present disclosure.

FIG. 7 is a block diagram of a packet processing apparatus applied to a DPU according to an embodiment of the present disclosure.

FIG. 8 is a schematic diagram of a hardware structure of a computer device according to an embodiment of the present disclosure.

### DETAILED DESCRIPTION OF EMBODIMENTS

In order to make the objectives, technical solutions and advantages of the embodiments of the present disclosure clearer, the technical solutions in the embodiments of the present disclosure will be described hereunder clearly and comprehensively with reference to the drawings in the embodiments of the present disclosure. Apparently, the described embodiments are merely some rather than all of the embodiments of the present disclosure. All other embodiments obtained by persons of ordinary skill in the art based on the embodiments of the present disclosure without creative efforts shall fall within the protection scope of the present disclosure.

With the evolution of cloud computing services, DPU (Data Processing Unit) is particularly important as the foundation of hardware virtualization. DPU has a strong demand for the network. However, network traffic is bursty, and therefore network failures may occur in case of traffic surge. Specifically, the slow path and the fast path on the DPU process corresponding packets respectively. The slow unit implemented by code on the slow path is used to process a packet that requires special processing (which may be referred to as a slow packet for example). The fast unit implemented by code on the fast path is used to process a common packet that does not require special processing (which may be referred to as a fast packet). A common practice is to process packets to the best of one's ability. Specifically, the slow unit and the fast unit may request to the buffer unit, in a polling manner, to process corresponding packets. However, such a way of processing packets to the best of one's ability cannot solve the problem of head-of-line blocking. For example, network packets are generally processed in sequence according to an order in which the network packets enter the buffer unit. However, a packet buffer space of the buffer unit is limited, and a problem of head-of-line blocking easily occurs.

Compared with a conventional DPU packet processing method that processes packets to the best of one's ability, the DPU in the present disclosure monitors the buffer watermark of the packet buffer space of the buffer unit, and when the buffer watermark is higher than the preset threshold, sends the first packet in the buffer unit to the first transmission path whose packet processing rate is lower than that of the second transmission path, to achieve the result of prioritizing the first transmission path on the DPU for processing the first packet, that is, discarding the first packet that requires a longer processing time with priority, thereby significantly reducing impact on the processing of the second packet on the second transmission path on the DPU, and avoiding a buffer space full as much as possible, to reduce or even avoid the occurrence of head-of-line blocking. It can be seen that the present disclosure can significantly improve the efficiency of processing a network packet by the DPU in the network card device in the cloud network, and improve the packet processing performance of the cloud network.

According to an embodiment of the present disclosure, an embodiment of a packet processing method applied to a DPU is provided. It should be noted that the steps shown in the flowcharts of the drawings may be executed in a computer system such as a group of computer-executable instructions, and although the logical order is shown in the flowcharts, in some cases, the steps shown or described may be executed in an order different from the order here.

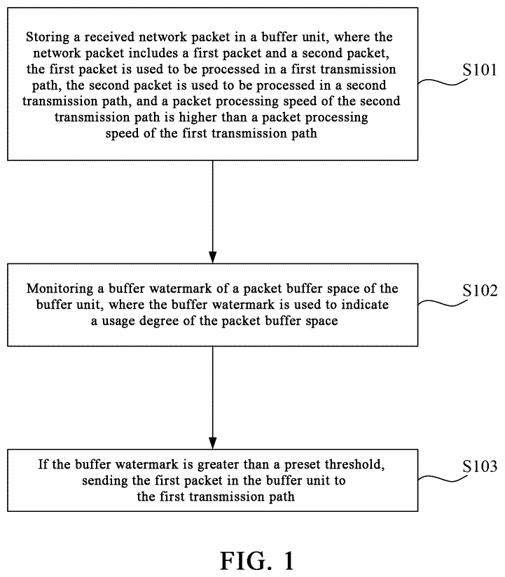

In this embodiment, a packet processing method applied to a DPU is provided, which can be used for a DPU in a network card device. FIG. 1 is a flowchart of a packet processing method applied to a DPU according to an embodiment of the present disclosure. As shown in FIG. 1, the flow includes the following steps:

Step S101, storing a received network packet in a buffer unit, where the network packet includes a first packet and a second packet, the first packet is used to be processed in a first transmission path on a DPU, the second packet is used to be processed in a second transmission path on the DPU, and a packet processing speed of the second transmission path is higher than a packet processing speed of the first transmission path.

In the embodiments of the present disclosure, the buffer unit may be a cache implemented by hardware, and is used to store the received network packet; the first packet is a packet that requires special processing, and the second packet is a common packet that does not require special processing.

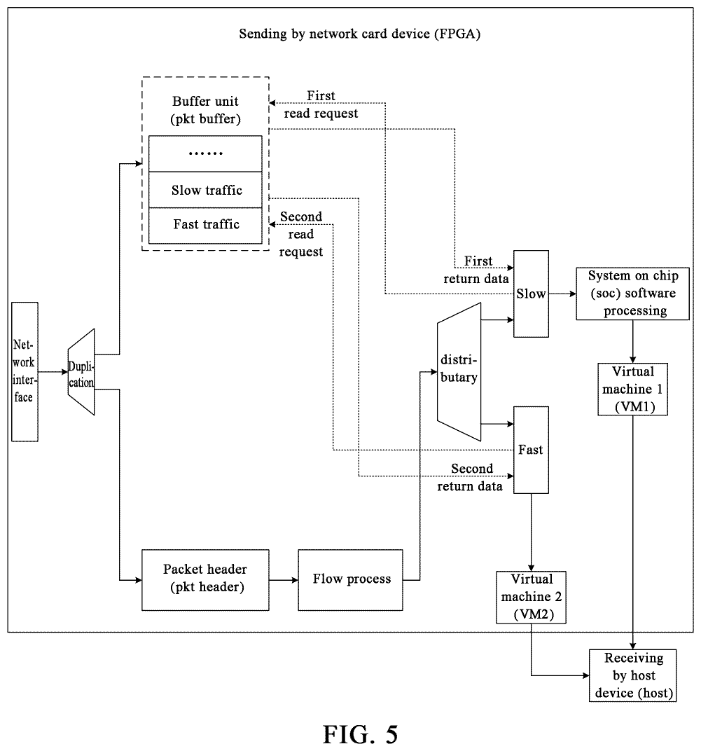

As shown in FIG. 5, the first transmission path on the DPU involved in this embodiment is the slow path, and the second transmission path on the DPU is the fast path. Correspondingly, the first packet involved in this embodiment is the slow packet, and the second packet is the fast packet. In the fast path on the DPU, the network packet may be forwarded directly through the hardware of the network device or a dedicated chip, which avoids overhead of software processing. The packet processing mode of the fast path on the DPU can achieve low-latency and high-throughput data transmission, and provide a high-performance network experience. The slow path on the DPU is used to process a packet that requires special processing, such as security check, traffic monitoring, load balance, etc. In the slow path on the DPU, the packet needs to go through more processing steps, including checking the packet header, decrypting or encrypting, access control, etc. The slow path on the DPU in this embodiment may be implemented by dedicated software or code, to implement a particular network service and function.

In some optional implementations, before the storing, in step S101, the received network packet in the buffer unit, the packet processing method applied to the DPU in the present disclosure further includes:

Step a1: obtaining packet header information of a current network packet to be stored in the buffer unit.

Specifically, after receiving the network packet through the network interface and before storing the network packet in the buffer unit, the network device can obtain packet header (pkt header) information of the network packet.

Step a2: identifying, according to the packet header information, that the current network packet is the first packet or the second packet.

In this embodiment, if it is determined, according to the packet header information, that the current network packet is a packet that can be processed by the fast path on the DPU, such as a common packet or an ACK (Acknowledge character) packet, it means that the current network packet is a fast packet. For the fast packet, this embodiment may perform a basic packet parsing process. If it is determined, according to the packet header information, that the current network packet is a packet that cannot be processed by the fast path on the DPU, such as a special packet or an abnormal packet, it means that the current network packet is a slow packet. For the slow packet, the network card device may perform more detailed packet parsing, and extract all protocol header information, such as an IP (Internet Protocol) address, a destination IP address, a TCP (Transmission Control Protocol)/UDP (User Datagram Protocol) port, etc., and may repackage and send the network packet. Certainly, based on the content of this embodiment, the basis for classifying and identifying the network packet may also be a protocol type, a port number, or the like.

Therefore, this embodiment can determine the type of the received network packet before buffering the received network packet, that is, determine whether the current network packet is a fast packet or a slow packet. It can be seen that this embodiment can determine the type of all buffered packets, so that the fast unit and the slow unit can be informed of the type of the buffered network packet, so that the fast unit and the slow unit can timely send a read request to the buffer unit, thereby facilitating the improvement of the processing efficiency of the network packet, and further reducing the possibility of head-of-line blocking.

In some optional implementations, step al includes:

Step b1: duplicating the current network packet to be stored in the buffer unit to obtain a packet to be processed.

The packet to be processed is identical to the current network packet.

Step b2: extracting the packet header information from the packet to be processed.

Specifically, this embodiment can parse the packet to be processed, to parse out the packet header information from the packet to be processed, that is, parse out the packet header information of the current network packet. The packet header information may include, but is not limited to, for example, a destination IP address, a source IP address, a protocol type, a packet length, an identifier, and the like.

In this embodiment, the network packet is duplicated, and the packet header information is extracted from the network packet obtained through duplication, so that the packet buffering process and the packet header extraction process are performed in parallel, and the processing efficiency of the network packet is further improved.

In some optional implementations, step a2 includes:

Step c1: obtaining a preset flow table, where the preset flow table is used to record network data stream information.

The preset flow table in this embodiment may specifically be a DPU flow table, and specifically, a network card flow table (Flow Table). The Flow Table records related information of a network data stream, such as a source IP address, a destination IP address, a protocol type, a port number, and the like. The network card device in this embodiment may identify and classify a data stream through information recorded in the preset flow table, and in this embodiment, specifically, identify a type of the current network packet according to the information recorded in the preset flow table.

Step c2: querying the preset flow table based on the packet header information, and determining, according to a query result, that the current network packet is the first packet or the second packet.

In this embodiment, the traffic type may be determined by querying the DPU flow table. The traffic type may include two types: the first packet and the second packet. For example, the packet header information is matched with the data stream related information in the preset flow table, and according to the matching result, it is determined that the current network packet is the first network packet or the second network packet. For different types of network packets, the slow path and the fast path on the DPU with different processing performance are used for processing respectively.

In this embodiment, the preset flow table is queried to determine whether the current network packet is the first packet or the second packet, which can not only improve the accuracy of the network packet type determination, but also improve the efficiency of the network packet type determination.

Step S102: monitoring a buffer watermark of a packet buffer space of the buffer unit, where the buffer watermark is used to indicate a usage degree of the packet buffer space.

Specifically, the buffer watermark may be used to characterize the number of packets stored in the buffer unit.

The buffer watermark is monitored in the embodiments of the present disclosure mainly to determine whether the buffer watermark reaches a congestion watermark. The congestion watermark may be characterized by a preset threshold described below.

Therefore, in this embodiment, whether the buffer watermark is greater than the preset threshold is determined, and the determination result is that the buffer watermark is greater than the preset threshold, or the buffer watermark is less than or equal to the preset threshold.

Step S103: if the buffer watermark is greater than the preset threshold, sending the first packet in the buffer unit to the first transmission path.

If the buffer watermark is less than or equal to the preset threshold, the first packet in the buffer unit may be sent to the first transmission path and/or the second packet in the buffer unit may be sent to the second transmission path in a polling manner.

In this embodiment, the preset threshold may be, for example, 50%. Certainly, the preset threshold involved in the present disclosure may also be a dynamically adjusted value.

It can be seen that in this embodiment, when the buffer watermark is high, the first transmission path on the DPU is discarded with priority. When the buffer watermark is not high (that is, when there is no congestion), the first transmission path and the second transmission path on the DPU are discarded according to the default packet discarding mode (such as the polling manner).

As shown in FIG. 4, the present disclosure can be applied to a scenario where a network card device (for example, a network card device that can be designed based on FPGA, where FPGA stands for Field Programmable Gate Array) discards packets to a host through the slow path and the fast path on the DPU.

In conjunction with the foregoing embodiments, the network card device involved in the present disclosure may be, for example, a DPU (Data Processing Unit), but is not limited thereto.

As shown in FIG. 5, in the slow path on the DPU in the embodiments of the present disclosure, the first packet may be processed sequentially by a slow unit (implemented by code), a system on chip (SoC), and a virtual machine 1 (VM1) and then sent to the host device. In the fast path on the DPU in the embodiments of the present disclosure, the second packet may be processed sequentially by a fast unit (implemented by code) and a virtual machine 2 (VM2) and then sent to the host device.

This embodiment may work according to the working principle shown in FIG. 5: (1) receiving the current network packet through the network interface, and then duplicating the current network packet to obtain two current network packets, where one current network packet is sent to the buffer unit (pkt buffer) configured to buffer the network packet; (2) extracting the packet header (pkt header) from the other current network packet, and performing flow processing on the packet header to determine the type of the current network packet, that is, to determine whether the current network packet is the fast packet or the slow packet. The fast packets in the buffer unit form a fast traffic, and the slow packets in the buffer unit form a slow traffic; (3) performing distributary processing, and notifying the slow unit and the fast unit of the type of the current packet, so that the slow unit and the fast unit can send the packet read request to the buffer unit; (4) the slow unit and the fast unit in this embodiment may send read requests to the buffer unit in turn in a polling manner. For example, the slow unit is configured to send a first read request to the buffer unit to request the slow packet, and the buffer unit responds to the first read request by feeding back first return data (i.e., the slow packet). The fast unit is configured to send a second read request to the buffer unit to request the fast packet, and the buffer unit responds to the second read request by feeding back second return data (i.e., the fast packet); (5) the slow unit, the system on chip, and the virtual machine 1 sequentially process the slow packet and then send the slow packet to the host device; and the fast unit and the virtual machine 2 sequentially process the fast packet and then send the fast packet to the host device.

Compared with the related art, this embodiment introduces calculation of the buffer watermark of the packet buffer space of the pkt buffer in the process of processing the network packet through the slow path on the DPU, and discards packets with priority at the entry of the slow path when the buffer watermark is greater than the preset threshold. In this way, the traffic of the fast path is not affected.

Compared with a conventional DPU packet processing method that processes packets to the best of one's ability, the packet processing method applied to the DPU provided in this embodiment is a congestion control strategy, which uses a manner of monitoring the buffer watermark of the packet buffer space of the buffer unit. The monitoring of the buffer watermark belongs to a manner of monitoring the buffer depth of the buffer unit. In this embodiment, when the buffer watermark is greater than the preset threshold, the first packet in the buffer unit is sent to the first transmission path whose packet processing rate is lower than that of the second transmission path, to achieve the result of prioritizing the first transmission path on the DPU for processing the first packet, that is, discarding the first packet that requires a longer processing time with priority, thereby significantly reducing impact on the processing of the second packet on the second transmission path on the DPU, and avoiding a buffer space full as much as possible, to reduce or even avoid the occurrence of head-of-line blocking. It can be seen that the embodiments of the present disclosure can significantly improve the efficiency of processing a network packet by the DPU in the network card device in the cloud network, and greatly improve the packet processing performance of the cloud network.

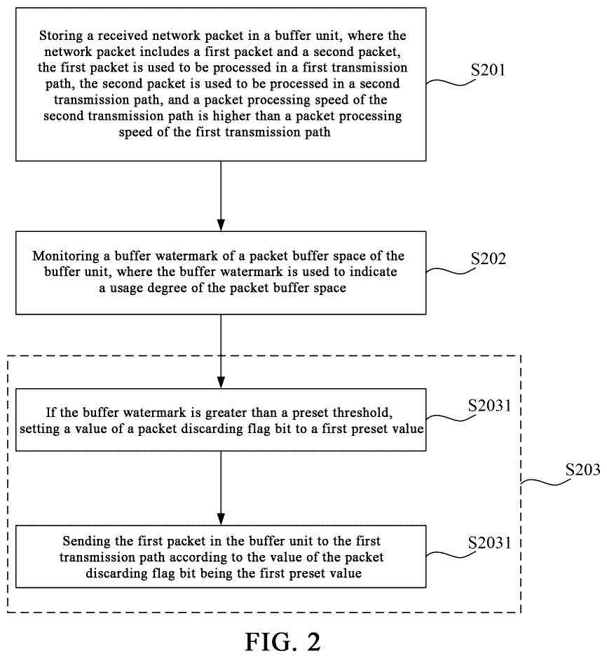

In this embodiment, a packet processing method applied to a DPU is provided, which can be used for a DPU in a network card device. FIG. 2 is a flowchart of a packet processing method applied to a DPU according to an embodiment of the present disclosure. As shown in FIG. 2, the flow includes the following steps:

Step S201, storing a received network packet in a buffer unit, where the network packet includes a first packet and a second packet, the first packet is used to be processed in a first transmission path, the second packet is used to be processed in a second transmission path, and a packet processing speed of the second transmission path is higher than a packet processing speed of the first transmission path. For details, see step S101 of the embodiment shown in FIG. 1, which will not be repeated here.

Step S202, monitoring a buffer watermark of a packet buffer space of the buffer unit, where the buffer watermark is used to indicate a usage degree of the packet buffer space. For details, see step S102 of the embodiment shown in FIG. 1, which will not be repeated here.

Step S203, if the buffer watermark is greater than a preset threshold, sending the first packet in the buffer unit to the first transmission path.

Specifically, step S203 includes:

Step S2031, if the buffer watermark is greater than the preset threshold, setting a value of a packet discarding flag bit to a first preset value.

The packet discarding flag bit in the embodiments of the present disclosure may be represented by threshold_drop_flag, and the first preset value may be, for example, 1. In conjunction with the preset threshold of 50% in the foregoing embodiment, if the buffer watermark is greater than 50%, threshold_drop_flag=1 may be set.

Step S2032: sending the first packet in the buffer unit to the first transmission path according to the value of the packet discarding flag bit being the first preset value.

In this embodiment, if threshold_drop_flag=1, the first transmission path on the DPU is discarded in this embodiment. Specifically, if threshold_drop_flag=1, the slow unit sends the first read request to the buffer unit, and the buffer unit responds to the first read request by sending the slow packet to the slow unit.

If the buffer watermark is less than or equal to the preset threshold, the first packet in the buffer unit may be sent to the first transmission path on the DPU and/or the second packet in the buffer unit may be sent to the second transmission path on the DPU in the polling manner. Specifically, it includes: if the buffer watermark is less than or equal to the preset threshold, the value of the packet discarding flag bit is set to second preset value, and according to the value of the packet discarding flag bit being the second preset value, the first packet in the buffer unit may be sent to the first transmission path on the DPU and/or the second packet in the buffer unit may be sent to the second transmission path on the DPU in the polling manner. More specifically, the slow unit and the fast unit in this embodiment send corresponding read requests to the buffer unit in turn (a polling manner), and the buffer unit responds to the received read requests by sending the fast packet to the fast unit and the slow packet to the slow unit.

In the embodiments of the present disclosure, whether the first transmission path on the DPU is discarded with priority may be determined according to the value of the packet discarding flag bit. This method can further improve the accuracy of packet discarding, thereby ensuring that the network packet is processed with priority through the first transmission path on the DPU when the buffer watermark is high, and improving the reliability of the packet processing process.

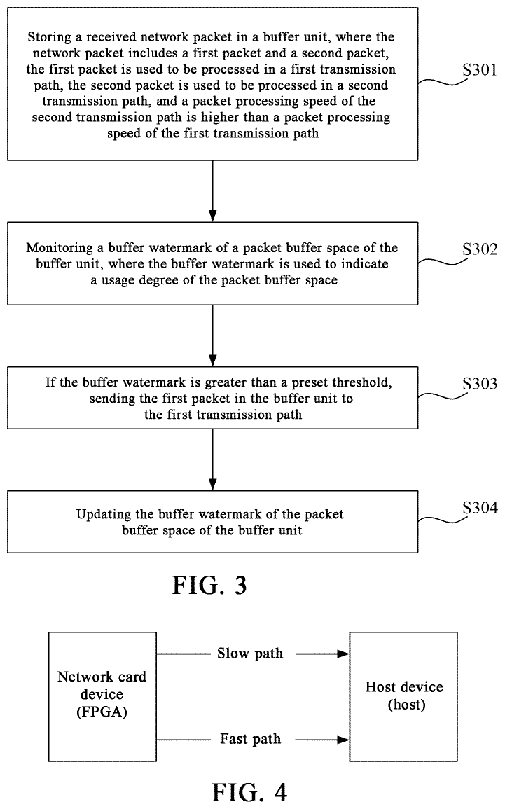

In this embodiment, a packet processing method applied to a DPU is provided, which can be used for a DPU in a network card device. FIG. 3 is a flowchart of a packet processing method applied to a DPU according to an embodiment of the present disclosure. As shown in FIG. 3, the flow includes the following steps:

Step S301, storing a received network packet in a buffer unit, where the network packet includes a first packet and a second packet, the first packet is used to be processed in a first transmission path, the second packet is used to be processed in a second transmission path, and a packet processing speed of the second transmission path is higher than a packet processing speed of the first transmission path. For details, see step S101 of the embodiment shown in FIG. 1, which will not be repeated here.

Step S302, monitoring a buffer watermark of a packet buffer space of the buffer unit, where the buffer watermark is used to indicate a usage degree of the packet buffer space. For details, see step S102 of the embodiment shown in FIG. 1, which will not be repeated here.

Step S303, if the buffer watermark is greater than a preset threshold, sending the first packet in the buffer unit to the first transmission path. For details, see step S103 of the embodiment shown in FIG. 1, which will not be repeated here.

Step S304, updating the buffer watermark of the packet buffer space of the buffer unit.

In this embodiment, the buffer watermark of the packet buffer space is updated in time, which provides support for the next step of accurately determining the buffer watermark, and enables the buffer unit to timely buffer the packet newly received by the network interface, which improves the timeliness of packet processing and further optimizes the performance of the network device.

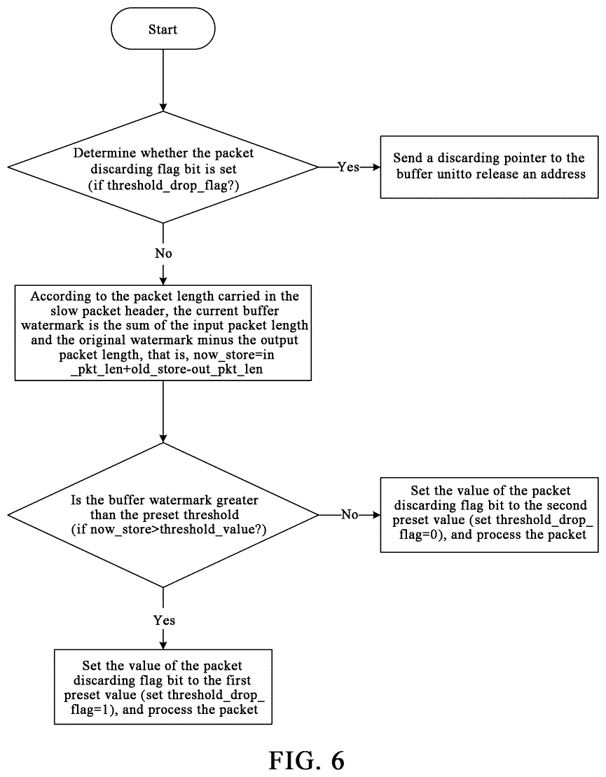

As shown in FIG. 6 and in conjunction with FIG. 5, after the network packet enters the slow path on the DPU, the slow unit determines whether the packet discarding flag bit is set (if threshold_drop_flag?), that is, determines whether the value of the packet discarding flag bit is the first preset value or the second preset value. If yes (that is, the packet discarding flag bit is the first preset value or the second preset value), it means that an action of sending the network packet to the fast unit or the slow unit has been performed once, and therefore a discarding pointer is sent to the buffer unit to release an address, so as to update information in the buffer unit, to avoid repeated parsing or matching of the same network packet. If not, according to the packet length carried in the slow packet header, the current buffer watermark is a sum of an input packet length and an original watermark minus an output packet length, that is, now_store=in_pkt_len+old_store-out_pkt_len. Next, whether the buffer watermark is greater than the preset threshold (if now_store>threshold_value?) is determined. If yes, the value of the packet discarding flag bit is set to the first preset value (threshold_drop_flag=1 is set), and the packet is processed. If not, the value of the packet discarding flag bit is set to the second preset value (threshold_drop_flag=0 is set), and the packet is processed.

Therefore, the present disclosure implements continuous monitoring of the buffer watermark of the packet buffer space of the buffer unit, that is, monitoring of the buffer depth of the buffer unit. Therefore, when the buffer watermark is greater than the preset threshold, the first packet in the buffer unit is sent to the first transmission path whose packet processing rate is lower than that of the second transmission path, to achieve the result of prioritizing the first transmission path on the DPU for processing the first packet, that is, discarding the first packet that requires a longer processing time with priority, thereby avoiding the problem of head-of-line blocking caused by the fact that the slow packet cannot be processed in time, and therefore, significantly reducing impact on the processing of the second packet on the second transmission path on the DPU, and avoiding a buffer space full as much as possible, to reduce or even avoid the occurrence of head-of-line blocking. It can be seen that the present disclosure can significantly improve the efficiency of processing a network packet by the DPU in the network card device in the cloud network, and greatly improve the packet processing performance of the cloud network.

In conclusion, the present disclosure reduces the occurrence of the problem of head-of-line blocking by monitoring the buffer depth. Through this method, the slow path and the fast path on the DPU can process corresponding traffic more effectively. In some actual effect display results, the packet processing method applied to the DPU based on the present disclosure can increase the bandwidth of the fast path on the DPU by 1.5 times.

In this embodiment, a packet processing apparatus applied to a DPU is further provided. The apparatus is used to implement the foregoing embodiments and preferred implementations, which will not be repeated here. As used hereinafter, the term “module” may implement a combination of software and/or hardware with predetermined functions. Although the apparatus described in the following embodiments is preferably implemented in software, the implementation of hardware, or a combination of software and hardware, is also possible and contemplated.

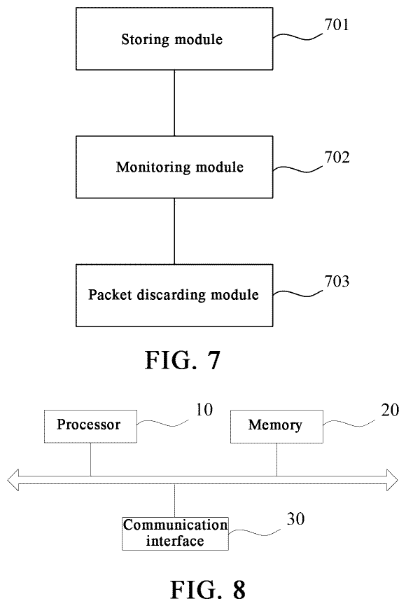

This embodiment provides a packet processing apparatus applied to a DPU. As shown in FIG. 7, the apparatus includes:
a storing module 701, configured to store a received network packet in a buffer unit, where the network packet includes a first packet and a second packet, the first packet is used to be processed in a first transmission path, the second packet is used to be processed in a second transmission path, and a packet processing speed of the second transmission path is higher than a packet processing speed of the first transmission path;
a monitoring module 702, configured to monitor a buffer watermark of a packet buffer space of the buffer unit, where the buffer watermark is used to indicate a usage degree of the packet buffer space; and
a packet discarding module 703, configured to send the first packet in the buffer unit to the first transmission path according to the buffer watermark being greater than a preset threshold.

In some optional implementations, the packet discarding module 703 is further configured to send the first packet in the buffer unit to the first transmission path and/or send the second packet in the buffer unit to the second transmission path according to the buffer watermark being less than or equal to the preset threshold.

The packet discarding module 703 includes:

a setting submodule, configured to set a value of a packet discarding flag bit to a first preset value according to the buffer watermark being greater than the preset threshold.

A sending submodule is configured to send the first packet in the buffer unit to the first transmission path according to the value of the packet discarding flag bit being the first preset value.

In some optional implementations, the packet processing apparatus applied to the DPU further includes:

an updating module, configured to update the buffer watermark of the packet buffer space of the buffer unit after sending the first packet in the buffer unit to the first transmission path.

In some optional implementations, the packet processing apparatus applied to the DPU further includes:

an obtaining module, configured to obtain packet header information of a current network packet to be stored in the buffer unit.

An identifying module is configured to identify, according to the packet header information, that the current network packet is the first packet or the second packet.

In some optional implementations, the obtaining module includes:
a duplicating submodule, configured to duplicate the current network packet to be stored in the buffer unit to obtain a packet to be processed.

An extracting submodule is configured to extract the packet header information from the packet to be processed.

In some optional implementations, the identifying module includes:
a flow table obtaining submodule, configured to obtain a preset flow table, where the preset flow table is used to record network data stream information.

A packet determining submodule is configured to query the preset flow table based on the packet header information, and to determine, according to a query result, that the current network packet is the first packet or the second packet.

In some optional implementations, the first transmission path is the slow path, and the second transmission path is the fast path.

Further functional descriptions of the above modules and units are the same as those of the above corresponding embodiments, and will not be repeated here.

The packet processing apparatus applied to the DPU in this embodiment is presented in the form of functional units, and the units here refer to an ASIC (Application Specific Integrated Circuit) circuit, a processor and a memory that execute one or more pieces of software or fixed programs, and/or other devices that can provide the above functions.

An embodiment of the present disclosure further provides a computer device, which has the above packet processing apparatus applied to the DPU shown in FIG. 7.

Please refer to FIG. 8. FIG. 8 is a schematic diagram of a structure of a computer device according to an optional embodiment of the present disclosure. As shown in FIG. 8, the computer device includes: one or more processors 10, a memory 20, and interfaces for connecting components, including a high-speed interface and a low-speed interface. The components communicate with each other through different buses and may be installed on a common motherboard or installed in other manners as required. The processor may process instructions executed in the computer device, including instructions stored in or on the memory to display graphic information of a GUI on an external input/output apparatus (such as a display device coupled to the interface). In some optional implementations, if required, multiple processors and/or multiple buses may be used in conjunction with multiple memories and multiple memories. Similarly, multiple computer devices may be connected, and each device provides part of necessary operations (for example, as a server array, a group of blade servers, or a multi-processor system). In FIG. 8, one processor 10 is taken as an example.

The processor 10 may be a central processor, a network processor, or a combination thereof. The processor 10 may further include a hardware chip. The hardware chip may be an application-specific integrated circuit, a programmable logic device, or a combination thereof. The programmable logic device may be a complex programmable logic device, a field programmable gate array, a generic array logic, or any combination thereof.

The memory 20 stores instructions executable by at least one processor 10, so that the at least one processor 10 performs the method shown in the above embodiments.

The memory 20 may include a program storage region and a data storage region, where the program storage region may store an operating system and an application required for at least one function; and the data storage region may store data created according to the use of the computer device, etc. In addition, the memory 20 may include a high-speed random-access memory, and may also include a non-transitory memory, such as at least one disk storage device, a flash memory device, or other non-transitory solid-state storage devices. In some optional implementations, the memory 20 optionally includes a memory provided remotely relative to the processor 10, and these remote memories may be connected to the computer device through a network. Examples of the above network include but are not limited to the Internet, an intranet, a local area network, a mobile communication network, and a combination thereof.

The memory 20 may include a volatile memory, such as a random-access memory; the memory may also include a non-volatile memory, such as a flash memory, a hard disk or a solid-state hard disk; and the memory 20 may also include a combination of the above kinds of memories.

The computer device further includes a communication interface 30 for the computer device to communicate with other devices or communication networks.

An embodiment of the present disclosure further provides a computer-readable storage medium, the above method according to the embodiments of the present disclosure may be implemented in hardware or firmware, or implemented as computer code that can be recorded on a storage medium, or implemented as computer code downloaded through a network and originally stored in a remote storage medium or a non-transitory machine-readable storage medium and to be stored in a local storage medium, so that the method described here may be stored in such software processing on a storage medium using a general computer, a special processor, or programmable or special hardware. The storage medium may be a magnetic disk, an optical disk, a read-only storage memory, a random storage memory, a flash memory, a hard disk, a solid-state hard disk, or the like. Further, the storage medium may also include a combination of the above kinds of memories. It can be understood that a computer, a processor, a microprocessor controller, or programmable hardware includes a storage component that can store or receive software or computer code, and when the software or computer code is accessed and executed by the computer, the processor, or the hardware, the method shown in the above embodiments is implemented.

Although the embodiments of the present disclosure are described in conjunction with the drawings, persons of ordinary skill in the art may make various modifications and variations without departing from the spirit and scope of the present disclosure, and these modifications and variations all fall within the protection scope defined by the appended claims.

I/We claim:

1. A packet processing method applied to a data processing unit, DPU, wherein the method comprises:
storing a received network packet in a buffer unit, wherein the network packet comprises a first packet and a second packet, the first packet is used to be processed in a first transmission path, the second packet is used to be processed in a second transmission path, and a packet processing speed of the second transmission path is higher than a packet processing speed of the first transmission path;
monitoring a buffer watermark of a packet buffer space of the buffer unit, wherein the buffer watermark is used to indicate a usage degree of the packet buffer space; and
in response to the buffer watermark being greater than a preset threshold, sending the first packet in the buffer unit to the first transmission path.

2. The method of claim 1, wherein the method further comprises:
in response to the buffer watermark being less than or equal to the preset threshold, sending the first packet in the buffer unit to the first transmission path and/or sending the second packet in the buffer unit to the second transmission path.

3. The method of claim 1, wherein in response to the buffer watermark being greater than the preset threshold, sending the first packet in the buffer unit to the first transmission path comprises:
in response to the buffer watermark being greater than the preset threshold, setting a value of a packet discarding flag bit to a first preset value; and
sending the first packet in the buffer unit to the first transmission path according to the value of the packet discarding flag bit being the first preset value.

4. The method of claim 1, wherein after sending the first packet in the buffer unit to the first transmission path, the method further comprises:
updating the buffer watermark of the packet buffer space of the buffer unit.

5. The method of claim 1, wherein before storing the received network packet in the buffer unit, the method further comprises:
obtaining packet header information of a current network packet to be stored in the buffer unit; and
identifying, according to the packet header information, that the current network packet is the first packet or the second packet.

6. The method of claim 5, wherein obtaining the packet header information of the current network packet to be stored in the buffer unit comprises:
duplicating the current network packet to be stored in the buffer unit to obtain a packet to be processed; and
extracting the packet header information from the packet to be processed.

7. The method of claim 5, wherein identifying, according to the packet header information, that the current network packet is the first packet or the second packet comprises:
obtaining a preset flow table, wherein the preset flow table is used to record network data stream information; and
querying the preset flow table based on the packet header information, and determining, according to a query result, that the current network packet is the first packet or the second packet.

8. The method of claim 1, wherein
the first transmission path is a slow path; and
the second transmission path is a fast path.

9. A computer device, comprising:
a memory and a processor, wherein the memory and the processor communicate with each other, the memory has a computer instruction stored therein, and the computer instruction, when executed by the processor, causes the processor to:
store a received network packet in a buffer unit, wherein the network packet comprises a first packet and a second packet, the first packet is used to be processed in a first transmission path, the second packet is used to be processed in a second transmission path, and a packet processing speed of the second transmission path is higher than a packet processing speed of the first transmission path;
monitor a buffer watermark of a packet buffer space of the buffer unit, wherein the buffer watermark is used to indicate a usage degree of the packet buffer space; and
in response to the buffer watermark being greater than a preset threshold, send the first packet in the buffer unit to the first transmission path.

10. The computer device of claim 9, wherein the computer instruction further causes the processor to:
in response to the buffer watermark being less than or equal to the preset threshold, sending the first packet in the buffer unit to the first transmission path and/or sending the second packet in the buffer unit to the second transmission path.

11. The computer device of claim 9, wherein the computer instruction for in response to the buffer watermark being greater than the preset threshold, sending the first packet in the buffer unit to the first transmission path further causes the processor to:
in response to the buffer watermark being greater than the preset threshold, set a value of a packet discarding flag bit to a first preset value; and
send the first packet in the buffer unit to the first transmission path according to the value of the packet discarding flag bit being the first preset value.

12. The computer device of claim 9, wherein after sending the first packet in the buffer unit to the first transmission path, the computer instruction further causes the processor to:
update the buffer watermark of the packet buffer space of the buffer unit.

13. A non-transitory computer-readable storage medium, wherein the computer-readable storage medium has a computer instruction stored thereon, and the computer instruction, when executed by a processor, causes the processor to:
store a received network packet in a buffer unit, wherein the network packet comprises a first packet and a second packet, the first packet is used to be processed in a first transmission path, the second packet is used to be processed in a second transmission path, and a packet processing speed of the second transmission path is higher than a packet processing speed of the first transmission path;
monitor a buffer watermark of a packet buffer space of the buffer unit, wherein the buffer watermark is used to indicate a usage degree of the packet buffer space; and
in response to the buffer watermark being greater than a preset threshold, send the first packet in the buffer unit to the first transmission path.

14. The non-transitory computer-readable storage medium of claim 13, wherein the computer instruction further causes the processor to:
in response to the buffer watermark being less than or equal to the preset threshold, sending the first packet in the buffer unit to the first transmission path and/or sending the second packet in the buffer unit to the second transmission path.

15. The non-transitory computer-readable storage medium of claim 13, wherein the computer instruction for in response to the buffer watermark being greater than the preset threshold, sending the first packet in the buffer unit to the first transmission path further causes the processor to:
in response to the buffer watermark being greater than the preset threshold, set a value of a packet discarding flag bit to a first preset value; and
send the first packet in the buffer unit to the first transmission path according to the value of the packet discarding flag bit being the first preset value.

16. The non-transitory computer-readable storage medium of claim 13, wherein after sending the first packet in the buffer unit to the first transmission path, the computer instruction further causes the processor to:
update the buffer watermark of the packet buffer space of the buffer unit.

17. The non-transitory computer-readable storage medium of claim 13, wherein before storing the received network packet in the buffer unit, the computer instruction further causes the processor to:
obtain packet header information of a current network packet to be stored in the buffer unit; and
identify, according to the packet header information, that the current network packet is the first packet or the second packet.

18. The non-transitory computer-readable storage medium of claim 17, wherein the computer instruction for obtaining the packet header information of the current network packet to be stored in the buffer unit further causes the processor to:
duplicating the current network packet to be stored in the buffer unit to obtain a packet to be processed; and
extracting the packet header information from the packet to be processed.

19. The non-transitory computer-readable storage medium of claim 17, wherein the computer instruction for identifying, according to the packet header information, that the current network packet is the first packet or the second packet further causes the processor to:
obtain a preset flow table, wherein the preset flow table is used to record network data stream information; and
query the preset flow table based on the packet header information, and determining, according to a query result, that the current network packet is the first packet or the second packet.

20. The non-transitory computer-readable storage medium of claim 13, wherein
the first transmission path is a slow path; and
the second transmission path is a fast path.
